(19) United States
(12) Patent Application Publication
(10) Pub. No.: US 2025/0304050 A1
(43) Pub. Date: Oct. 2, 2025

(54) COLLISION PREDICTION DEVICE AND COLLISION PREDICTION METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Yuki TAKAHASHI, Tokyo (JP); Takeo MIKI, Isehara-shi (JP); Tomoya TAKEDA, Atsugi-shi (JP)

(21) Appl. No.: 19/085,755

(22) Filed: Mar. 20, 2025

(30) Foreign Application Priority Data
Mar. 26, 2024 (JP) 2024-050179

(51) Int. Cl. B60W 30/09; B60W 10/18; B60W 30/095; B60W 50/00

(52) U.S. Cl. CPC B60W 30/09; B60W 10/18; B60W 30/0956; B60W 50/0097; B60W 2520/105; B60W 2540/106; B60W 2554/4041

(57) ABSTRACT

A collision prediction device includes: an object position detection unit detecting a current position of an object; a movement path prediction unit predicting a movement path of an own vehicle; and a collision judgment unit executing a collision judgment as to whether there is a probability of collision between the own vehicle and the object. The collision judgment unit executes: (a) processing to permit actuation of an automatic braking depending on the collision judgment if an accelerator judgment condition including that a manipulation amount of an accelerator pedal of the own vehicle or a change rate of the manipulation amount is equal to or greater than a threshold is satisfied, and the object is present in the movement path; and (b) processing to prohibit the actuation of the automatic braking if the accelerator judgment condition is satisfied, but the object is not present in the movement path.

### CROSS-REFERENCE TO RELATED APPLICATION

This application is based on and claims the benefit of priority from Japanese Patent Application No. 2024-50179, the disclosure of which is incorporated in its entirety herein by reference.

### TECHNICAL FIELD

The present disclosure relates to a collision prediction device and a collision prediction method for a vehicle.

### BACKGROUND

JP 2008-213535 A discloses a collision prediction device which obtains an intersection point between a curved movement path of an own vehicle and a linear movement path of an opponent vehicle and judges whether the own vehicle and the opponent vehicle collide based on a time at which each of the own vehicle and the partner vehicle reaches the intersection point.

### SUMMARY

However, the known art does not take in consideration an “erroneous pressing” that the driver of the own vehicle strongly presses an accelerator pedal instead of a brake pedal by mistake. When the accelerator pedal is erroneously pressed, it is preferable to use an automatic braking for avoiding or mitigating collision. However, the case of strongly pressing the accelerator pedal includes not only the case of erroneous pressing but also the case of the driver intentionally accelerating. For example, a case is conceivable in which an object is not present in the movement path of the own vehicle at the present moment and is turning so that the own vehicle accelerates based on the premise that collision will not occur. Since the turning of the object is not taken into consideration in the above-described known art, collision judgment is established in such a case, raising a problem that an automatic braking is actuated unnecessarily.

On the other hand, a method is also conceivable of permitting actuation of an automatic braking as long as the object is present on the movement path of the own vehicle when the driver strongly presses the accelerator pedal. However, in this case, there is a case where the object is present on the movement path of the own vehicle at the present moment, but both actually slip past each other and do not collide, raising a problem that an automatic braking is actuated unnecessarily. Therefore, there is demand for a technology to avoid or mitigate collision while preventing unnecessary actuation of an automatic braking.

According to an aspect of the present disclosure, a collision prediction device is provided. This collision prediction device includes: an object position detection unit configured to detect a current position of an object; a movement path prediction unit configured to predict a movement path of an own vehicle; and a collision judgment unit configured to execute a collision judgment as to whether there is a probability of collision between the own vehicle and the object, using a relationship between the movement path of the own vehicle and the current position of the object. The collision judgment unit is configured to execute: (a) processing to permit actuation of an automatic braking depending on the collision judgment, in response to an accelerator judgment condition including that a manipulation amount of an accelerator pedal of the own vehicle or a rate of change with time of the manipulation amount is equal to or greater than a threshold being satisfied, and the object being present in the movement path; and (b) processing to prohibit the actuation of an automatic braking depending on the collision judgment, in response to the accelerator judgment condition being satisfied, but the object being not present in the movement path.

According to an aspect of the present disclosure, a collision prediction device is provided. This collision prediction device includes: an electronic control unit comprising a processor and configured to: detect a current position of an object; predict a movement path of an own vehicle; and execute a collision judgment as to whether there is a probability of collision between the own vehicle and the object, using a relationship between the movement path of the own vehicle and the current position of the object, wherein the electronic control unit is configured to execute: (a) processing to permit actuation of an automatic braking depending on the collision judgment, in response to an accelerator judgment condition including that a manipulation amount of an accelerator pedal of the own vehicle or a rate of change with time of the manipulation amount is equal to or greater than a threshold being satisfied, and the object being present in the movement path, and (b) processing to prohibit the actuation of the automatic braking depending on the collision judgment, in response to the accelerator judgment condition being satisfied, but the object being not present in the movement path.

According to an aspect of the present disclosure, a collision prediction method is provided. This collision prediction method e includes: an object position detection step of detecting a current position of an object; a movement path prediction step of predicting a movement path of an own vehicle; and a collision judgment step of executing a collision judgment as to whether there is a probability of collision between the own vehicle and the object, using a relationship between the movement path of the own vehicle and the current position of the object, wherein the collision judgment step includes executing: (a) processing to permit actuation of an automatic braking depending on the collision judgment, in response to an accelerator judgment condition including that a manipulation amount of an accelerator pedal of the own vehicle or a rate of change with time of the manipulation amount is equal to or greater than a threshold being satisfied, and the object being present in the movement path, and (b) processing to prohibit the actuation of the automatic braking depending on the collision judgment, in response to the accelerator judgment condition being satisfied, but the object being not present in the movement path.

According to the above collision prediction devices and collision prediction method, unnecessary actuation of an automatic braking can be prevented when the object is not present in the movement path of the own vehicle. Further, in a case where the object is present in the movement path of the own vehicle at the time of the accelerator pedal being strongly pressed, but the collision probability is actually low, collision can be avoided or mitigated while preventing unnecessary actuation of an automatic braking.

### BRIEF DESCRIPTION OF THE DRAWINGS

In the accompanying drawings:

FIG. 1 is a block diagram illustrating a configuration of a vehicle control system;

FIG. 2 is an explanatory diagram illustrating an example of a movement path of an own vehicle and a position of an object;

FIG. 3 is an explanatory diagram illustrating another example of a movement path of an own vehicle and a position of an object; and

FIG. 4 is a flowchart illustrating a procedure of collision prediction processing.

### DETAILED DESCRIPTION OF EMBODIMENTS

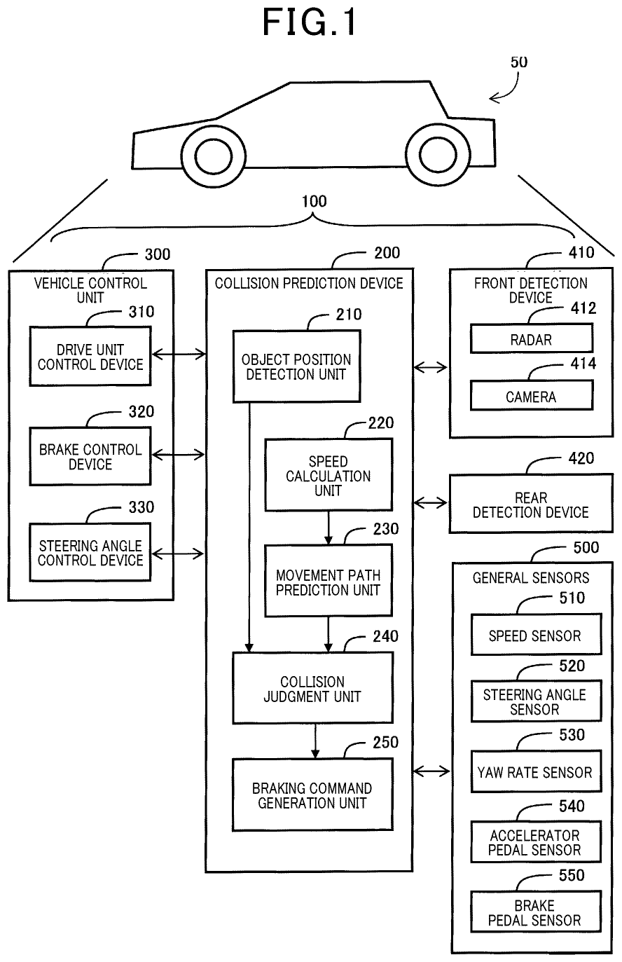

As illustrated in FIG. 1, a vehicle 50 of the present embodiment includes a vehicle control system 100. The vehicle control system 100 includes a collision prediction device 200, a vehicle control unit 300, a front detection device 410, a rear detection device 420, and general sensors 500. As described herein, the vehicle 50 is also referred to as an “own vehicle 50”.

The vehicle control unit 300 includes a drive unit control device 310, a brake control device 320, and a steering angle control device 330. The drive unit control device 310 has a function of controlling a drive unit (not illustrated) that drives wheels of the vehicle 50. As the drive unit of the wheels, one or more prime movers of an internal combustion engine and an electric motor can be used. The brake control device 320 executes brake control of the vehicle 50. The brake control device 320 is configured as, for example, an electronically controlled brake system (ECB). The steering angle control device 330 controls the steering angle of the wheels of the vehicle 50. The “steering angle” means the average steering angle of two front wheels of the vehicle 50. The steering angle control device 330 is configured as, for example, an electric power steering system (EPS).

The front detection device 410 uses a vehicle-mounted sensor to acquire information regarding various objects such as bodies and road facilities (a lane, an intersection, a traffic light, etc.) being present in front of the own vehicle 50. In the present embodiment, the front detection device 410 has a plurality of distance measuring devices including a radar 412 and a camera 414. As the radar 412, various radars that emit electromagnetic waves, such as a light detection and ranging (LiDAR) and a millimeter-wave radar, may be used. As the camera 414, a single lens camera and a stereo camera may be used. The camera 414 is preferably a color camera in order to distinguish the color of the object. The front detection device 410 may include another distance measuring device such as an ultrasonic sensor.

The rear detection device 420 acquires information regarding various objects such as bodies and road facilities being present in the rear of the own vehicle 50. The rear detection device 420 can also be configured to include vehicle-mounted sensors similar to the front detection device 410.

In the below-explained embodiment, an example in which the own vehicle 50 moves forward, and the position of the object is detected using the front detection device 410 will be described. However, the present disclosure is also applicable to a case where the own vehicle 50 moves backward.

The general sensors 500 include a speed sensor 510, a steering angle sensor 520, a yaw rate sensor 530, an accelerator pedal sensor 540, and a brake pedal sensor 550. The general sensors 500 are general sensors necessary for driving the vehicle 50.

The collision prediction device 200 is configured as an electronic control unit (ECU) containing a processor and a memory. In the collision prediction device 200, the processor executes a computer program stored in a nonvolatile storage medium to realize functions of an object position detection unit 210, a speed calculation unit 220, a movement path prediction unit 230, a collision judgment unit 240, and a braking command generation unit 250. Note that a part of the functions of the collision prediction device 200 may be realized by a hardware circuit.

The object position detection unit 210 detects the current position of the object. Examples of the object include movable bodies such as other vehicles and people as well as stationary bodies being present on roads. When the own vehicle 50 moves forward, the current position of the object is detected using the detection result of the front detection device 410. On the other hand, when the own vehicle 50 moves backward, the current position of the object is detected using the detection result of the rear detection device 420.

The speed calculation unit 220 calculates a current speed and a current acceleration of the own vehicle 50. The current speed can be obtained from the detection result of the speed sensor 510. The current acceleration can be calculated from a change in the current speed of the own vehicle 50.

The movement path prediction unit 230 predicts a movement path of the own vehicle 50. The movement path of the own vehicle 50 is a temporal positional change of the own vehicle 50. The movement path of the own vehicle 50 can be predicted using the current speed and the acceleration as well as a directional change of the own vehicle 50. The directional change of the own vehicle 50 is calculated from the detection results of the steering angle sensor 520 and the yaw rate sensor 530. The prediction of the movement path can be executed using the method disclosed in JP 2008-213535 A described above. For example, the radius of the movement path when the own vehicle 50 turns can be calculated using the turning center of the own vehicle 50. However, the movement path may also be predicted using a method other than the method disclosed in JP 2008-213535 A.

The collision judgment unit 240 executes a collision judgment as to whether there is a probability of collision between the own vehicle 50 and the object, using the relationship between the movement path of the own vehicle 50 and the current position of the object.

The braking command generation unit 250 prepares an emergency braking command for executing an automatic braking when there is a probability of collision between the own vehicle 50 and the object. In the present disclosure, the “automatic braking” can include both a braking executed by a system when a driver is not pressing a brake pedal at all and a braking executed by a system for supporting or amplifying a braking force when the driver is pressing a brake pedal. The emergency braking command prepared in the braking command generation unit 250 is transmitted to the brake control device 320. The brake control device 320 avoids or mitigates collision by executing the automatic braking according to the given emergency braking command.

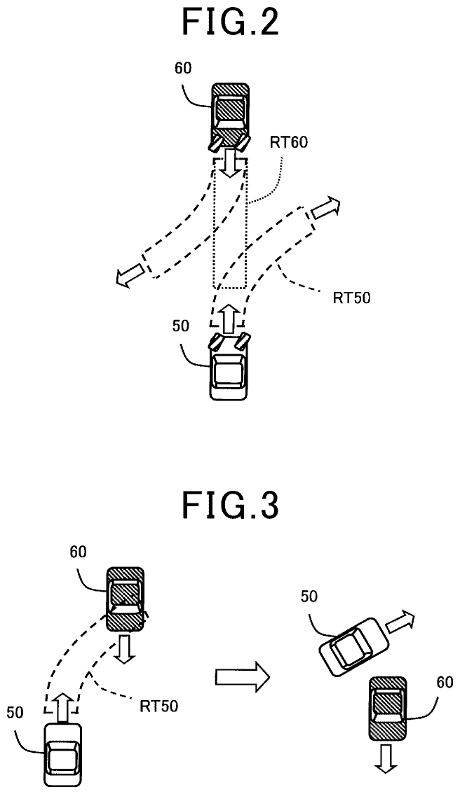

As illustrated in FIG. 2, when an object 60 is not present in a movement path RT50 of an own vehicle 50 at the present moment, and each of the object 60 and the own vehicle 50 turns, both are estimated not to collide, so that the driver of the own vehicle 50 may strongly press an accelerator pedal to accelerate the own vehicle 50. Therefore, in this case, it is preferable not to prohibit an automatic braking and permit actuation of an automatic braking depending on a collision judgment. However, in this case, the collision prediction device of JP 2008-213535 A described above takes in consideration only the straight ahead running of the object 60, so that a collision judgment is executed by determining an intersection point between a movement path RT60 when the object 60 runs straight ahead and the movement path RT50 of the own vehicle 50 and obtaining a time when the intersection point is reached. As a result, collision judgement is established in the collision prediction device of JP 2008-213535 A in spite of the fact that they do not actually collide, raising a problem that there is a probability of unnecessary actuation of an automatic braking. On the other hand, as described later, the unnecessary actuation of an automatic braking in such a case can be prevented in the present embodiment.

As illustrated in FIG. 3, there is a case where the object 60 is present in the movement path RT50 of the own vehicle 50 at the present moment, but both actually slip past each other and do not collide. In this case, a method is also conceivable of permitting the actuation of an automatic braking if the object 60 is present in the movement path RT50 of the own vehicle 50 when the driver of the own vehicle 50 strongly presses an accelerator pedal. However, in this case, a problem is also raised that there is a probability of unnecessary actuation of an automatic braking in spite of the fact that they do not actually collide. As described in detail below, in the present embodiment, the unnecessary actuation of an automatic braking can also be prevented in such a case.

In the present embodiment, the automatic braking is switched between permission and prohibition depending on whether the object 60 is present in the movement path RT50 of the own vehicle 50 when an accelerator pedal is strongly pressed. That is, if the object 60 is present in the movement path RT50 of the own vehicle 50 when an accelerator pedal is strongly pressed, the actuation of an automatic braking depending on the collision judgment is permitted. On the other hand, if the object 60 is not present in the movement path RT50 of the own vehicle 50 when an accelerator pedal is strongly pressed, the actuation of an automatic braking depending on the collision judgment is prohibited. This can solve the above-described problem.

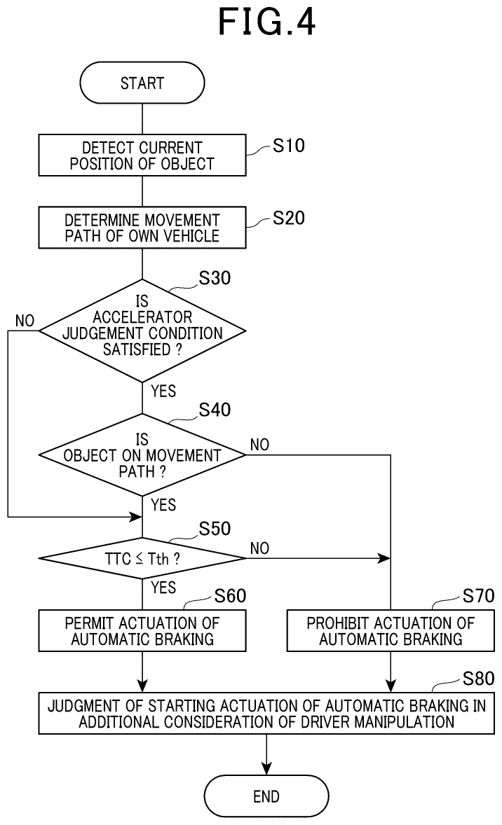

The collision prediction processing illustrated in FIG. 4 is periodically repeated after the own vehicle 50 starts up. In step S10, the object position detection unit 210 detects the current position of the object 60. In step S20, the movement path prediction unit 230 predicts the movement path RT50 of the own vehicle 50.

In step S30, the collision judgment unit 240 judges whether an accelerator judgment condition including that the manipulation amount of an accelerator pedal or the rate of change with time thereof is equal to or greater than a threshold is satisfied. The accelerator judgment condition is a condition representing a probability that an accelerator pedal is erroneously pressed by a driver. The accelerator judgment condition can also be called an “erroneous pressing judgment condition”. However, even when the accelerator judgment condition is satisfied, erroneous pressing does not necessarily occur, and a probability of erroneous pressing is merely suggested. A usable example of the accelerator judgment condition is any of the followings.

### <Accelerator Judgment Condition J1>

The accelerator judgment condition J1 is a condition that “the manipulation amount of an accelerator pedal is equal to or greater than a manipulation amount threshold”.

The probability of erroneous pressing is judged as being present when the judgment condition J1 is satisfied, and as being absent when the judgment condition J1 is not satisfied.

### <Accelerator Judgment Condition J2>

The accelerator judgment condition J2 is a condition that “the manipulation amount of an accelerator pedal is equal to or greater than a manipulation amount threshold, and the rate of change with time of the manipulation amount is equal to or greater than a change rate threshold”.

The probability of erroneous pressing is judged as being present when the judgment condition J2 is satisfied, and as being absent when the judgment condition J2 is not satisfied.

### <Accelerator Judgment Condition J3>

The accelerator judgment condition J3 is a condition including a first condition that “the manipulation amount of an accelerator pedal is equal to or greater than a first manipulation amount threshold” and a second condition that “the manipulation amount of an accelerator pedal is equal to or greater than a second manipulation amount threshold, and the rate of change with time of the manipulation amount is not less than a change rate threshold”.

The probability of erroneous pressing is judged as being present when at least one of the first condition and the second condition is satisfied, and as being absent when both the first condition and the second condition are not satisfied. Note that the second manipulation amount threshold is preferably set to a value smaller than the first manipulation amount threshold. For example, the first manipulation amount threshold is preferably set to a value equivalent to an accelerator opening of 90% or more which is close to a fully open accelerator state. The second manipulation amount threshold is preferably set to, for example, a value equivalent to an accelerator opening in a range of 50% to 80%.

The “manipulation amount of an accelerator pedal” means the pressing amount of an accelerator pedal. In the present embodiment, the accelerator judgment condition J3 is used. The accelerator judgment condition J3 is preferable in order to correctly recognize a state in which the driver strongly or quickly presses an accelerator pedal instead of a brake pedal by mistake so that the acceleration of the own vehicle 50 is predicted to rapidly increase immediately thereafter. However, another judgment condition may be adopted. The manipulation amount threshold and the change rate threshold are empirically set.

When the accelerator judgment condition is not satisfied in step S30, the processing proceeds to step S50 described later. On the other hand, when the accelerator judgment condition is satisfied, the processing proceeds to step S40.

In step S40, the collision judgment unit 240 judges whether the object 60 located in the current position is present in the movement path RT50 of the own vehicle 50. If the object 60 is not present in the movement path RT50 of the own vehicle 50, the processing proceeds to step S70, and the actuation of an automatic braking is prohibited. On the other hand, if the object 60 is present in the movement path RT50 of the own vehicle 50, the processing proceeds to step S50.

In step S50, the collision judgment unit 240 calculates a time to collision TTC and judges whether the time to collision TTC is equal to or less than a time threshold Tth. The time to collision TTC is a time to the time when the own vehicle 50 and the object 60 are predicted to collide. In the present embodiment, the time to collision TTC is calculated using the current speed and the current acceleration of the own vehicle 50 calculated in the speed calculation unit 220.

The judgment of step S70 is equivalent to a collision judgment as to whether there is a probability of collision between the own vehicle 50 and the object 60. When the time to collision TTC is greater than the time threshold Tth, the processing proceeds to step S70, and the actuation of an automatic braking is prohibited. On the other hand, when the time to collision TTC is equal to or less than the time threshold Tth, the processing proceeds to step S60, and the actuation of an automatic braking is permitted. However, the automatic braking is not actuated at this moment, and it is determined in step S80 whether the automatic braking is to be actually actuated.

In step S80, it is judged, in additional consideration of a driver manipulation, whether the braking command generation unit 250 starts the actuation of an automatic braking. For example, when a non-actuation condition such as the driver steering or continuing to strongly press the accelerator pedal is satisfied, it is judged that the actuation of an automatic braking is not to be started. Further, when the non-actuation condition is not satisfied, it is judged that the actuation of an automatic braking is to be started. For starting the actuation of an automatic braking, the braking command generation unit 250 generates an emergency braking command and transmits the emergency braking command to the brake control device 320 to actuate the automatic braking. As a result, collision between the own vehicle 50 and the object 60 can be avoided or mitigated.

Note that when the accelerator judgment condition is satisfied, the time to collision TTC may be calculated in step S50 using as the own vehicle acceleration a value that is the larger of a current acceleration of the own vehicle 50 and a set acceleration larger than the current acceleration. The current acceleration of the own vehicle 50 is a current acceleration calculated from an output of the speed sensor 510. The “set acceleration” is an acceleration set in advance and is set to a value that is equal to or greater than the maximum value of an acceleration predicted to occur in the own vehicle 50 when an accelerator pedal is erroneously pressed. The set acceleration is preferably set to, for example, a value that is equal to or greater than the maximum acceleration obtained when the manipulation amount of an accelerator pedal reaches the maximum value (accelerator opening: 100%) under the standard running condition that the own vehicle 50 runs on a flat road. The maximum acceleration can be confirmed by measuring the acceleration when the own vehicle 50 is accelerated from a stopped state to an accelerator opening of 100%. Since the set acceleration is determined under the condition that the own vehicle 50 is running on a flat road, there is a probability that, for example, the own vehicle 50 will be accelerated at an acceleration larger than this set acceleration if the own vehicle 50 is running down a slope. Further, when the own vehicle 50 is modified for some reason, there is also a probability that an acceleration equal to or greater than the set acceleration will occur. Therefore, when the accelerator judgment condition is satisfied, collision can be avoided or mitigated even if the speed of the own vehicle 50 rapidly increases, by calculating the time to collision TTC using as the own vehicle acceleration a value that is the larger of the set acceleration set in advance and the current acceleration.

Further, when the accelerator judgment condition is satisfied, the command value of the emergency braking command may be increased compared to when the accelerator judgment condition is not satisfied, such that a braking force is increased. Accordingly, a stronger automatic braking is actuated, so that collision can be more reliably avoided or mitigated even if the speed of the own vehicle 50 rapidly increases.

Further, when a distance between the object 60 and the own vehicle 50 exceeds a preset set distance threshold, the collision judgment may not be executed. This can prevent unnecessary collision judgment from being performed.

According to the above-described present embodiment, the actuation of an automatic braking depending on the collision judgment is permitted if the accelerator judgment condition including that the manipulation amount of the accelerator pedal of the own vehicle 50 or the rate of change with time thereof is equal to or greater than a threshold is satisfied, and the object 60 is present in the movement path RT50 of the own vehicle 50. Further, the actuation of an automatic braking depending on the collision judgment is prohibited if the accelerator judgment condition is satisfied, but the object 60 is not present in the movement path RT50 of the own vehicle 50. As a result, the automatic braking can be prevented from being unnecessarily actuated when the object 60 is not present in the movement path RT50 of the own vehicle 50. Further, in a case where the object 60 is present in the movement path RT50 of the own vehicle 50 at the time of the accelerator pedal being strongly pressed, but the collision probability is low, collision can be avoided or mitigated while preventing unnecessary actuation of an automatic braking.

The present disclosure is not limited to the above-described embodiments or modifications thereof, and can be realized in various aspects without departing from the scope thereof.

What is claimed is:

1. A collision prediction device, comprising:
an object position detection unit configured to detect a current position of an object;
a movement path prediction unit configured to predict a movement path of an own vehicle; and
a collision judgment unit configured to execute a collision judgment as to whether there is a probability of collision between the own vehicle and the object, using a relationship between the movement path of the own vehicle and the current position of the object,
wherein the collision judgment unit is configured to execute:
(a) processing to permit actuation of an automatic braking depending on the collision judgment, in response to an accelerator judgment condition including that a manipulation amount of an accelerator pedal of the own vehicle or a rate of change with time of the manipulation amount is equal to or greater than a threshold being satisfied, and the object being present in the movement path, and
(b) processing to prohibit the actuation of the automatic braking depending on the collision judgment, in response to the accelerator judgment condition being satisfied, but the object being not present in the movement path.

2. The collision prediction device according to claim 1,
wherein in response to the accelerator judgment condition being satisfied, the collision judgment unit is configured to calculate a time to collision using as an own vehicle acceleration a value that is the larger of a set acceleration set in advance and a current acceleration of the own vehicle.

3. The collision prediction device according to claim 2,
wherein the accelerator judgment condition is satisfied in response to at least one of a first condition that “the manipulation amount of the accelerator pedal is equal to or greater than a first manipulation amount threshold” and a second condition that “the manipulation amount of the accelerator pedal is equal to or greater than a second manipulation amount threshold and the rate of change with time of the manipulation amount is equal to or greater than a change rate threshold” being satisfied.

4. The collision prediction device according to claim 2,
wherein the set acceleration is a value that is equal to or greater than an acceleration when the manipulation amount of the accelerator pedal is a maximum value.

5. A collision prediction device, comprising:
an electronic control unit comprising a processor and configured to:
detect a current position of an object;
predict a movement path of an own vehicle; and
execute a collision judgment as to whether there is a probability of collision between the own vehicle and the object, using a relationship between the movement path of the own vehicle and the current position of the object,
wherein the electronic control unit is configured to execute:
(a) processing to permit actuation of an automatic braking depending on the collision judgment, in response to an accelerator judgment condition including that a manipulation amount of an accelerator pedal of the own vehicle or a rate of change with time of the manipulation amount is equal to or greater than a threshold being satisfied, and the object being present in the movement path, and
(b) processing to prohibit the actuation of the automatic braking depending on the collision judgment, in response to the accelerator judgment condition being satisfied, but the object being not present in the movement path.

6. A collision prediction method, comprising:
an object position detection step of detecting a current position of an object;
a movement path prediction step of predicting a movement path of an own vehicle; and
a collision judgment step of executing a collision judgment as to whether there is a probability of collision between the own vehicle and the object, using a relationship between the movement path of the own vehicle and the current position of the object,
wherein the collision judgment step includes executing:
(a) processing to permit actuation of an automatic braking depending on the collision judgment, in response to an accelerator judgment condition including that a manipulation amount of an accelerator pedal of the own vehicle or a rate of change with time of the manipulation amount is equal to or greater than a threshold being satisfied, and the object being present in the movement path, and
(b) processing to prohibit the actuation of the automatic braking depending on the collision judgment, in response to the accelerator judgment condition being satisfied, but the object being not present in the movement path.
